(19) United States
(12) Patent Application Publication
(10) Pub. No.: US 2010/0132264 A1
(43) Pub. Date: Jun. 3, 2010

(54) BI-FLOW INFLATABLE DOOR SEALS

(76) Inventors: Steven Campbell, Peosta, IA (US); Carl David Hardison, Preston, IA (US); Rodney Kern, Dubuque, IA (US); Perry Knutson, Lancaster, WI (US); Peter S. Schulte, East Dubuque, IL (US); Mark Ungs, Dubuque, IA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/325,931

(22) Filed: Dec. 1, 2008

(51) Int. Cl. E06B 7/18; E06B 3/00

(52) U.S. Cl. 49/477.1; 49/506

(57) ABSTRACT

An example of an inflatable seal for a door includes a bi-directional airflow pattern of frost-inhibiting heated air. The bi-directional flow pattern enables the seal's discharge opening and supply air blower to both be located well above the floor and preferably above the doorway. If the discharge opening is near the suction inlet of the blower, such an arrangement makes it possible to recover previously heated air by returning some of the warm air back to the blower. In some examples, the seal includes a supply air conduit and a return air conduit with one disposed within the other. The internal conduit may include a relatively stiff elbow to prevent that conduit from becoming kinked near an upper corner of the door.

### FIELD OF THE DISCLOSURE

This patent generally relates to door seals and, more specifically, to door seals that are inflatable.

### BACKGROUND

Insulated doors are often used to provide access to cold-storage lockers, which are rooms that provide large-scale refrigerated storage for the food industry. Doorways into such a room are often rather wide to allow forklift trucks to move large quantities of products in and out of the room. When closing off a refrigerated room, side-acting sliding doors are often preferred over other types of doors because they are generally easy to make thick with insulation to reduce the cooling load on the room. Refrigerated rooms, however, may have other types of doors such as swinging doors, roll-up doors, bi-fold doors, and vertically translating doors (e.g., overhead-storing doors).

Regardless of the type of door applied to a cold-storage locker, ineffectively sealing the edges around the door panels can create cooling losses and promote frost buildup in certain areas of the door. A particularly narrow seal, for instance, may be unable to span relatively wide air gaps and may provide insufficient thermal insulation. Air gaps can allow warm outside air to enter the refrigerated room where the warm air can condense and freeze on inner surfaces of the door and the room. Even without air gaps, seals with insufficient thermal insulation may conduct heat from exterior surfaces to the interior of the refrigerated room. This lowers the temperature of those exterior surfaces and promotes condensation and frost buildup.

It is known to provide an insulated door with inflatable seals. Inflatable seals typically comprise a fabric tube inflated by a blower that forces air into the tube. To maintain the tube at a temperature that inhibits frost from accumulating on the exterior of the seal, the tube might include a discharge hole such that the hole and the blower are at opposite ends of the tube. Such a design ensures a continuous flow of air through the full length of the tube, thus avoiding an otherwise trapped volume of air from being cooled to a frost-promoting temperature. Heating the air prior to forcing it through the tubular seal can further inhibit frost.

### BRIEF DESCRIPTION OF THE DRAWINGS

FIG. 1 is a front view showing an example door in a closed position.

FIG. 2 is a front view similar to FIG. 1 but showing the example door partially open.

FIG. 3 is a front view similar to FIGS. 1 and 2 but showing the example door in an open position.

FIG. 4 is a cross-sectional view taken along line 4-4 of FIG. 1.

FIG. 4a is a cross-sectional view similar to FIG. 4 but showing an alternate example of a door seal.

FIG. 5 is a front view of an inflatable seal for the example door of FIGS. 1-4, wherein the seal's outer conduit is shown sectioned to show the seal's internal conduit.

FIG. 6 is a front view similar to FIG. 3 but showing another example of a door and seal system.

FIG. 7 is a front view similar to FIG. 5 but illustrating the example seal system of FIG. 6.

FIG. 8 is a front view similar to FIGS. 5 and 7 but showing another example of an inflatable seal system.

FIG. 9 is a front view similar to FIGS. 5, 7 and 8 but showing yet another example of an inflatable seal system.

### DETAILED DESCRIPTION

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

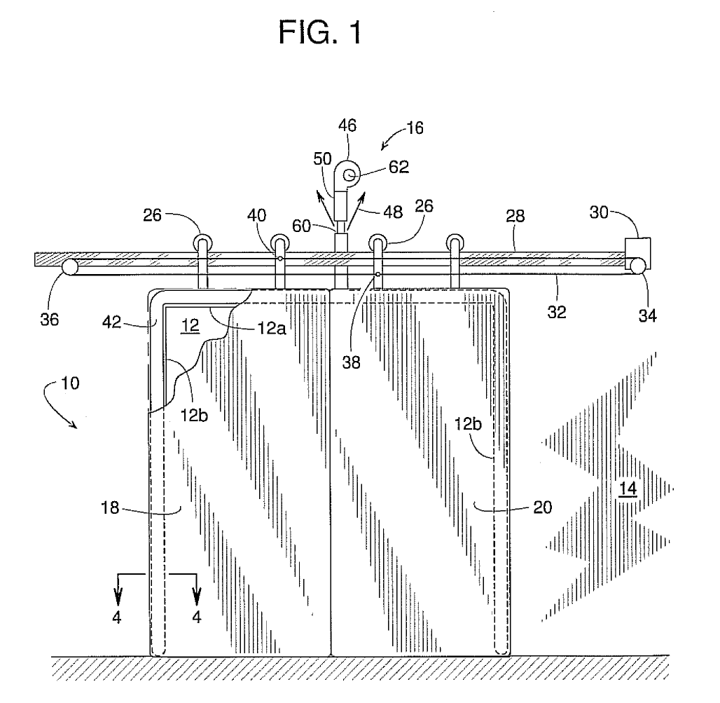

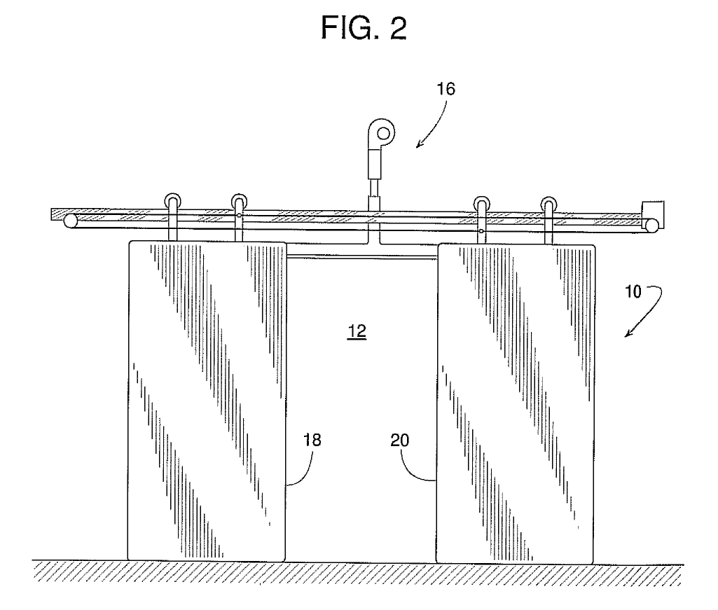

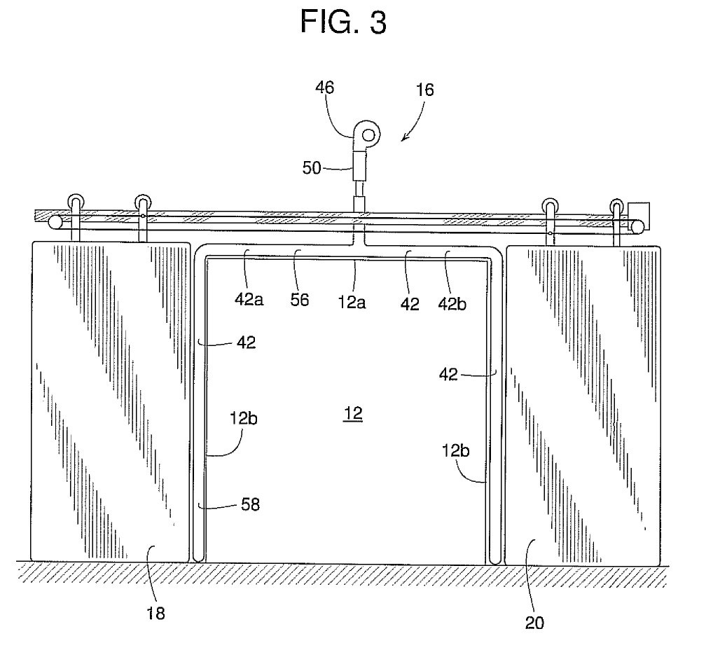

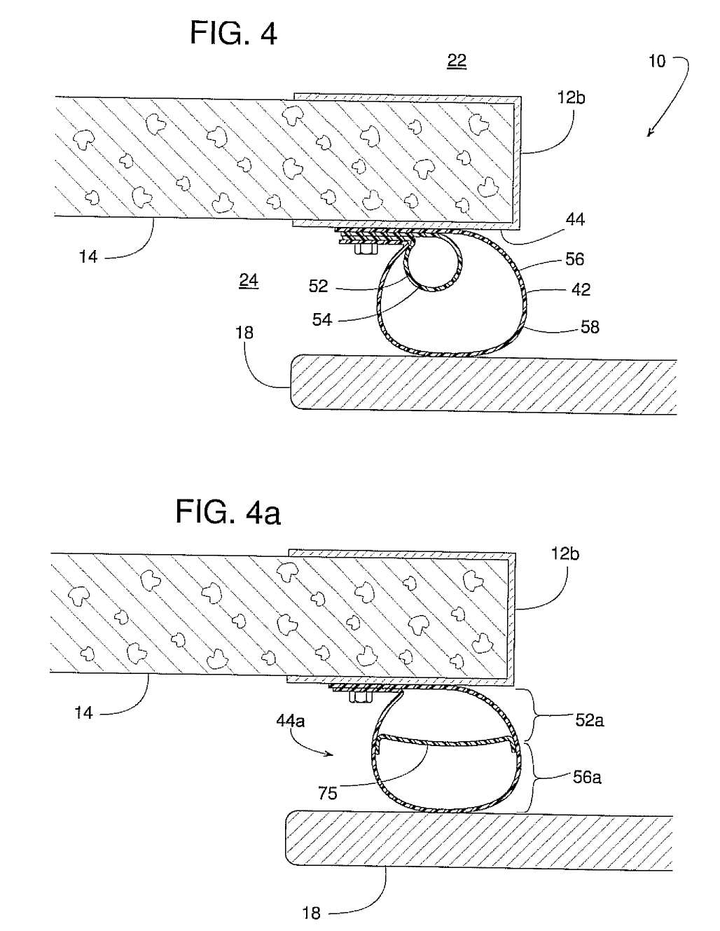

FIGS. 1-5 show an example door 10 having at least one door panel that can pivot, translate or otherwise move across a doorway 12 of a wall 14. Door 10 can help separate one area within a building from another, and an inflatable sealing system 16 helps prevent leakage between the two areas when door 10 is closed. Although the type of door and its surroundings may vary (e.g., the examples described herein may be applied to any size and type of door), an example will be described with reference to door 10 having a door panel in the form of two translating door panels 18 and 20 that help close off a cold storage locker. Other doors for other applications may have a unitary door panel (e.g., a roll-up door). Accordingly, as used herein “door panel” refers to any panel, whether unitary or in multiple parts, that closes a doorway opening. Door 10 helps separate a first area 22 of colder air from a second area 24 of warmer air, as shown in FIG. 4. In some cases, however, area 22 is the warmer area, and second area 24 is the colder area. In still other cases, the two areas 22 and 24 are of the same temperature, and door 10 divides the two areas for some reason other than temperature such as, for example, pest control, isolating a clean room, security, etc. FIG. 1 shows door 10 closed, FIG. 2 shows door 10 partially open, and FIG. 3 shows door 10 fully open.

For the examples illustrated in FIGS. 1-5, panels 18 and 20 are suspended from panel carriers 26 that can roll, slide, or otherwise travel along an overhead track 28. Track 28 can lie horizontally or lie at an incline. For cold storage applications, panels 18 and 20 preferably comprise a thermal insulating foam core encased in a protective cover. However, other panel structures are well within the scope of the present disclosure.

Door 10 could be manually operated, or a drive unit 30 can be used to open and close door 10. In some cases, drive unit 30 comprises a roller chain 32 supported between a motor-driven sprocket 34 and an idler sprocket 36. One fastener 38 connects a lower portion of chain 32 to panel 20 (e.g., via one of the panel carriers 26), and a second fastener 40 connects an upper portion of chain 32 to panel 18. Thus, the driven rotation of sprocket 34 determines whether panels 18 and 20 move toward each other to close door 10 or move apart to open the door 10.

To provide sealing along an upper edge 12a and two lateral edges 12b of doorway 12, sealing system 16 includes an inflatable seal 42 interposed between a doorway member 44 and door 10, comprised of door panels 18 and 20. The phrase, “doorway member” is defined to include any structure surrounding the doorway. Examples of doorway member 44 include, but are not limited to, the inner edges of a wall that define a doorway, a frame along the periphery of a doorway, and a wall surface that is adjacent a doorway. The phrase, “inflatable seal” is defined to include a pliable or flexible tube that expands or fills out under internal air pressure or a pliable or flexible tube having an outer wall that tightens in response to internal air pressure. Seal 42 can be attached to doorway member 44 and seal against door panels 18 and 20. Alternatively, seal 42 can be attached to panels 18 and 20 and seal against doorway member 44.

For the cold-storage examples shown in FIGS. 1-5, a blower 46 discharges air 48 through an electric heater 50 to inflate seal 42 with warm air, thereby inhibiting frost from collecting on or around the seal 42. In applications where frost or condensation is not a concern, heater 50 could be eliminated.

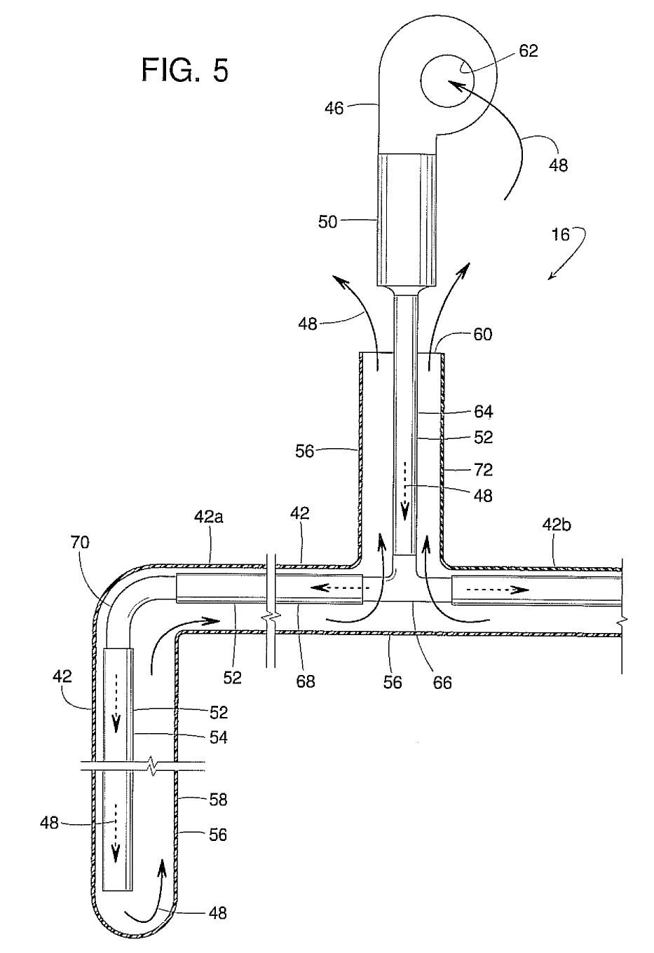

Although the actual construction and configuration of sealing system 16 may vary, the examples shown in FIGS. 1-5 (see FIG. 5 in particular) shows seal 42 comprising a supply conduit 52 with a downward-flow section 54, and the downward-flow section 54 is disposed within a return conduit 56 having an upward-flow section 58. Such a bi-flow pattern through seal 42 provides for an air discharge outlet 60 above doorway 12, which ensures sufficient warm airflow through seal 42 without the need for a discharge hole near the bottom of the seal 42. This advantageous airflow is facilitated by having separated supply and return paths associated with the air being provided to the seal. Moreover, in this example, the supply path (e.g., supply conduit 52) provides warmed air to the bottom of seal 42 at the inlet to the return path (e.g., return conduit 56) in an effort to ensure that this volume (e.g., furthest from the source of heat) nonetheless is provided with adequate heat for the application.

The airflow through sealing system 16 is generally depicted in FIG. 5. Blower 46 draws in ambient air 48 through a suction inlet 62 of blower 46 and then discharges air 48 through heater 50. The discharged heated air 48 flows through a supply tube 64 that conveys the air to one or more legs 42a and 42b of sealing system 16. In this example, a tee 66 delivers air approximately equally to legs 42a and 42b with similar flow patterns through both legs 42a and 42b. In leg 42a, air 48 flows sequentially through a tube 68 of supply conduit 52, an elbow 70 of supply conduit 52, through downward-flow section 54 of supply conduit 52, and out through the bottom of downward-flow section 54. From there, air 48 flows back up through upward-flow section 58 to inflate return conduit 56 for the purpose of sealing a gap between door 10 and doorway member 44. The air flowing in opposite directions through sections 54 and 58 is in heat exchange relationship via the wall of downward-flow section 54, thereby providing a more even distribution of heat throughout seal 42. Air 48 then flows horizontally through return conduit 56 and then up between the outer wall of supply tube 64 and the inner surface of a vertical section 72 of return conduit 56. Section 72 releases air 48 out through discharge outlet 60 where the discharged air mixes with atmosphere in the vicinity of suction inlet 62 of blower 46. Blower 46 thus draws in air that may include some previously heated air, thereby recovering otherwise wasted heat.

As for the construction of seal 42, particularly the examples of FIGS. 1-5, return conduit 56 may be made of a flexible or pliable material, such as fabric and/or plastic sheeting. Although the relatively warm air flowing through return conduit 56 helps inhibit the formation of frost, such frost can be further prevented by providing the return conduit's 56 wall material with some porosity so that relatively warm air within return conduit 56 actually passes through the return conduit's 56 outer wall. In other examples of return conduit 56, however, the return conduit's 56 wall material is impervious to air.

The internal supply conduit 52 can be made of a similar or different material as that of return conduit 56. For the examples illustrated in FIGS. 1-5, tube 68 and downward-flow section 54 are made of the same material as that of return conduit 56 and are assembled and mounted to doorway member 44, as shown in FIG. 4. Because in this example, tube 68 and downward-flow section 54 are rather pliable, the stiffer elbow 70 may be used for joining tube 68 and section 54 to prevent tube 68 or section 54 from kinking at the corner where items 54 and 68 connect, particularly when under compression while sealing.

In the illustrated example, the supply conduit 52 is smaller in cross-section than return conduit 56. The smaller cross-section helps prevent heat loss in the warmed air as it is being conveyed to the bottom of seal 42, as compared to moving the air through a conduit with a larger cross-section. As used herein, the term, “conduit,” refers to any structure that defines an airflow path.

The term, “conduit,” as used herein is intended to be construed broadly and not limited to a pipe or tube configuration. FIG. 4a shows a seal 44a, for example, which is an alternative to seal 42 of FIG. 4. With seal 44a, a fabric baffle 75 internal to seal 44a partitions seal 44a to separate a supply path or “conduit” 52a from the return path or “conduit” 56a. Heated air 48 from blower 46 and heater 50 flows down through supply conduit 52a along the vertical length of baffle 75 until the heated air reaches the lower end of seal 44a. Once at the bottom of seal 44a, the heated air flows from the lower end of supply conduit 52a into the lower end of return conduit 56a and then flows back up through return conduit 56a in a manner similar to that of return conduit 56 of FIG. 4. There are alternate ways in which air can transfer from supply conduit 52a to return conduit 56a at the lower end of seal 44a. In some examples, the vertical length of baffle 75 does not extend completely down to the bottom of seal 44a, so air from supply conduit 52a can simply flow down and underneath the lower edge of baffle 4 to enter return conduit 56a. In some examples, a hole in the lower end of baffle 75 conveys air from the lower end of supply conduit 52a to the lower end of return conduit 56a.

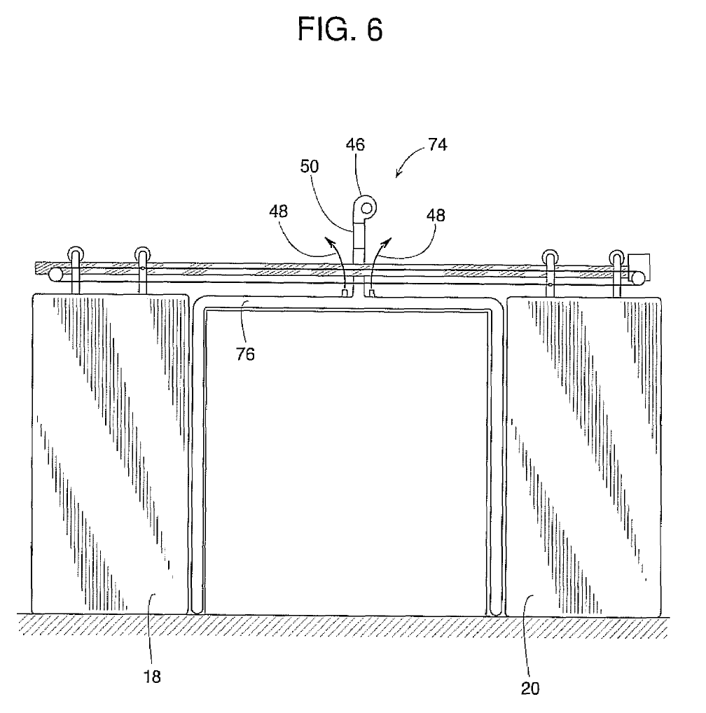

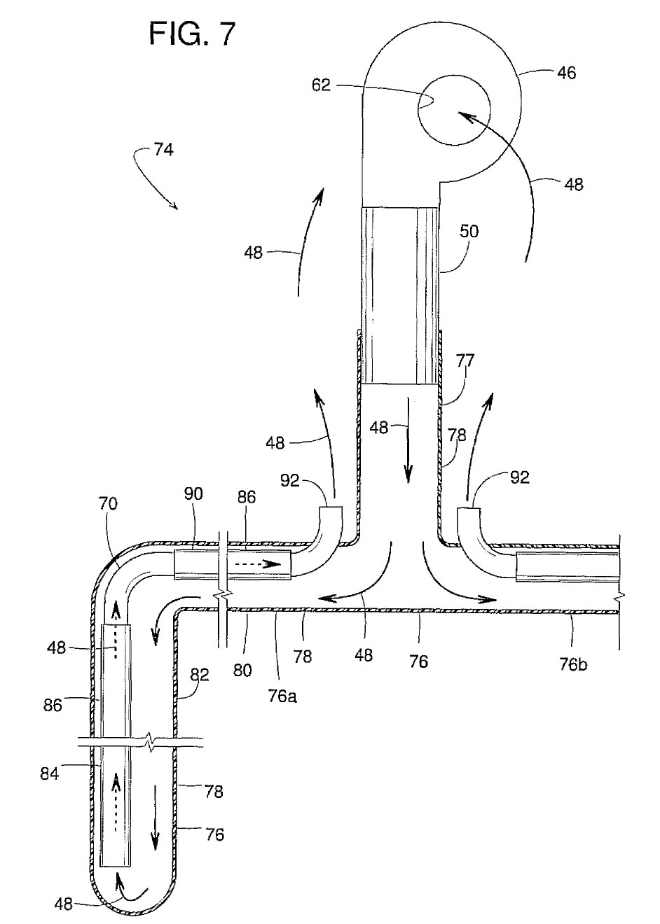

FIGS. 6 and 7 illustrate an alternate example of a seal system 74. Seal system 74 includes an inflatable seal 76 wherein heated air 48 discharged from heater 50 flows first down through a vertical section 77 of a supply conduit 78, which feeds two similar legs 76a and 76b of seal 76. In leg 76a, air 48 flow sequentially through a horizontal section 80 of supply conduit 78, down through a downward-flow section 82 of supply conduit 78, back up through an upward-flow section 84 of a return conduit 86, through elbow 70, through a horizontal section 90 of return conduit 86, and then through an outlet 92 where air 48 is released to atmosphere in the vicinity of suction inlet 62 of blower 46. Blower 46 thus draws in air that may include some previously heated air, thereby recovering otherwise wasted heat. While in this example, warmed air is not provided directly to the bottom of the seal (e.g., air passes through the inflated remainder of the seal 76 first), placing the inlet for the return path at the bottom of the seal 76 promotes flow of the warmed air to the bottom part of the seal 76 furthest from the heat source.

The construction and mounting of seals 42 and 76 are similar in that downward-flow section 82 of supply conduit 78 is similar to upward-flow section 58 of return conduit 56, upward-flow section 84 of return conduit 86 is similar to downward-flow section 54 of supply conduit 52, horizontal section 90 of return conduit 86 is similar to tube 68 of supply conduit 52, and horizontal section 80 of supply conduit 78 is similar to the horizontal section of return conduit 56. Although the aforementioned parts can be similar, they are not necessarily identical. Sections 84 and 90 depicted in FIG. 7, for instance, may need to be stiffer than tube 68 and section 54 of FIG. 5 to prevent the pressurized air in supply conduit 78 from collapsing sections 84 and 90.

To achieve a desired flow rate in this or any other example systems, internal seal temperature and/or air pressure within seal 42 or 76, the size of outlets 60 and 92 can be made larger or smaller to suit the application.

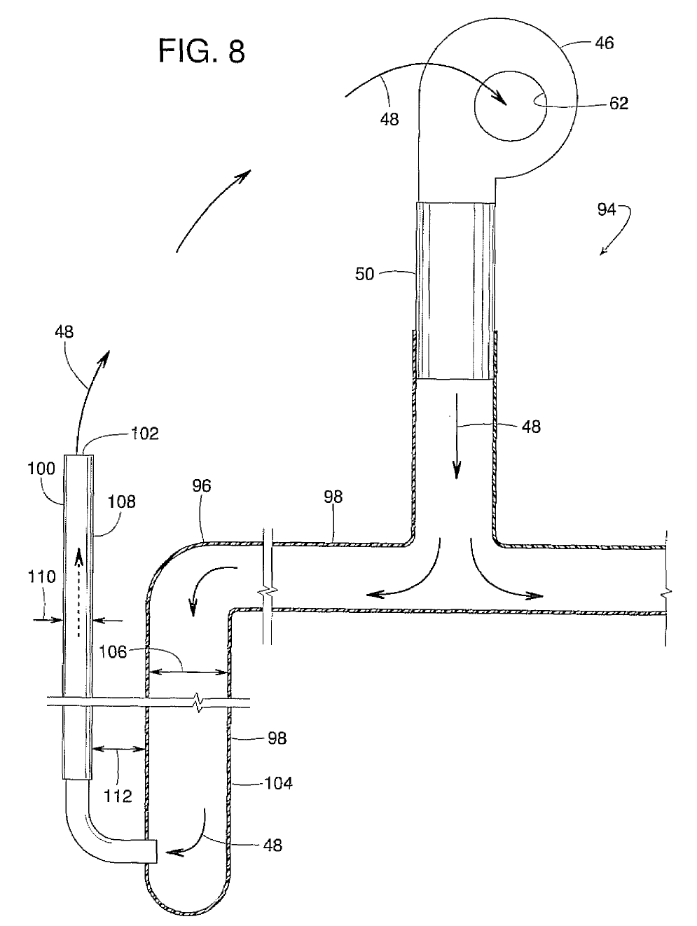

FIG. 8 illustrates an example seal system 94 that is similar to seal system 74. Seal system 94, however, comprises a seal 96 that includes a pliable supply conduit 98 with an external return conduit 100 rather than an internal one. Supply conduit 98 is what effectively seals the gap between door panel 18 and doorway member 44 in a manner similar to that of seals 42 and 76. Return conduit 100 has an outlet 102 that releases air 48 preferably above the doorway in the general vicinity of suction inlet 62 of blower 46. In this example, supply conduit 98 includes a downward-flow section 104 having an average supply diameter 106, and return conduit 100 includes an upward-flow section 108 having an average return diameter 110, wherein sections 104 and 108 are within a certain lateral distance 112 of each other. To reduce heat losses of seal 96, distance 112 preferably is less than the sum of average diameters 106 and 110. If one conduit is disposed inside another, as are the examples of seals 42 and 76, then the “certain lateral distance” between the two conduits is considered to be equal to zero. To provide seal 96 with greater compliance in sealing irregular gaps between door panel 18 and doorway member 44, and to prevent return conduit 100 from obstructing the movement of a door panel, average supply diameter 106 preferably is greater than average return diameter 110.

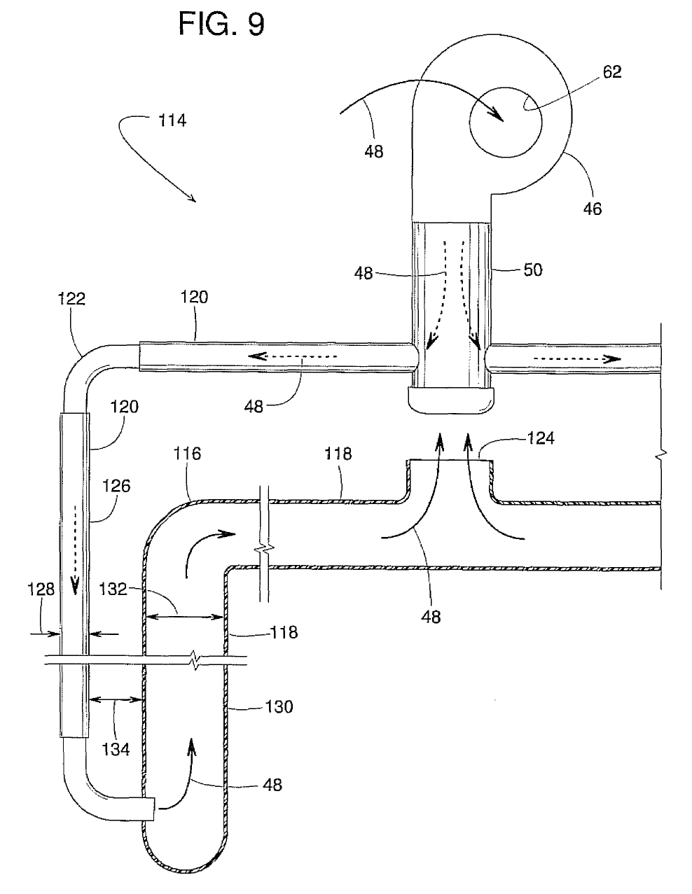

FIG. 9 illustrates an example seal system 114 that is similar to seal system 94 of FIG. 8. System 114, however, comprises a seal 116 that includes a pliable return conduit 118 downstream of an external supply conduit 120. Blower 46 with heater 50 discharges heated air 48 to supply conduit 120. An elbow 122 directs air 48 from supply conduit 120 into the lower end of return conduit 118, thereby inflating return conduit 118 for the purpose of sealing a gap between a door panel and a doorway member. Return conduit 118 has an outlet 124 that releases air 48 preferably above the doorway in the general vicinity of suction inlet 62 of blower 46. In this example, supply conduit 120 includes a downward-flow section 126 having an average supply diameter 128, and return conduit 118 includes an upward-flow section 130 having an average return diameter 132, wherein sections 126 and 130 are within a certain lateral distance 134 of each other. Distance 134 preferably is less than the sum of average diameters 128 and 132. To provide seal 116 with greater compliance in sealing irregular gaps between a door panel and a doorway member, average supply diameter 128 preferably is smaller than average return diameter 132.

At least some of the aforementioned examples include one or more features and/or benefits including, but not limited to, the following:

In some examples, a door includes an inflatable seal with a bi-directional flow pattern.

In some examples, an inflatable seal eliminates the need for a discharge opening at the lower end of the door.

In some examples, an inflatable seal releases air well above the floor and preferably near or above the upper edge of a doorway at an elevation where air in the room tends to be warmer than at lower elevations closer to the floor.

In some examples, an inflatable seal releases air above a doorway, near a suction inlet of a blower.

In some examples, an inflatable seal system recovers and circulates previously heated air.

In some examples, an inflatable seal includes a supply conduit installed within a pliable return conduit.

In some examples, an inflatable seal includes a return conduit installed within a pliable supply conduit.

In some examples, an inflatable seal contains an internal elbow that is relatively stiff to prevent an internal air conduit from becoming kinked.

In some examples, an inflatable seal includes supply and return conduits that are within a certain lateral distance of each.

Although certain example methods, apparatus and articles of manufacture have been described herein, the scope of the coverage of this patent is not limited thereto. On the contrary, this patent covers all methods, apparatus and articles of manufacture fairly falling within the scope of the appended claims either literally or under the doctrine of equivalents.

1. A door adjacent a doorway member exposed to air, the door comprising:
a door panel that is movable relative to the doorway member;
an inflatable seal interposed between the doorway member and the door panel, the inflatable seal includes a supply conduit and a return conduit, one of the supply conduit and the return conduit is disposed within the other; and
a blower in fluid communication with the supply conduit such that air discharged from the blower flows down through the supply conduit and back up through the return conduit.

2. The door of claim 1, wherein the supply conduit is inside the return conduit.

3. The door of claim 2, further comprising an elbow inside the return conduit, downstream of the blower, and in series-flow relationship with the supply conduit, wherein the elbow is stiffer than the supply conduit.

4. The door of claim 1, wherein the return conduit is inside the supply conduit.

5. The door of claim 4, further comprising an elbow inside the supply conduit and downstream of the return conduit, wherein the elbow is stiffer than the return conduit.

6. The door of claim 1, wherein the return conduit defines an outlet that releases air above the doorway.

7. The door of claim 1, wherein the return conduit defines an outlet that releases air to the blower.

8. The door of claim 1, further comprising a heater in heat transfer relationship with the air flowing to the supply conduit and the return conduit.

9. The door of claim 1, wherein the air flowing through the supply conduit is in heat exchange relationship with the air flowing through the return conduit.

10. A door adjacent a doorway member exposed to air, the door comprising:
a door panel that is movable relative to the doorway member;
an inflatable seal interposed between the doorway member and the door panel, the inflatable seal includes a supply conduit and a return conduit, the supply conduit has a downward-flow section having an average supply diameter, the return conduit has an upward-flow section having an average return diameter, the downward-flow section and the upward-flow section are within a certain lateral distance of each other, wherein the certain lateral distance is less than the average supply diameter plus the average return diameter; and
a blower in fluid communication with the supply conduit such that air discharged from the blower flows down through the supply conduit and back up through the return conduit.

11. The door of claim 10, wherein the downward-flow section is inside the upward-flow section.

12. The door of claim 11, further comprising an elbow inside the upward-flow section, downstream of the blower, and upstream of the downward-flow section, wherein the elbow is stiffer than the downward-flow section.

13. The door of claim 10, wherein the upward-flow section is inside the downward-flow section.

14. The door of claim 13, further comprising an elbow inside the downward-flow section and downstream of the upward-flow section, wherein the elbow is stiffer than the upward-flow section.

15. The door of claim 10, wherein the average supply diameter is smaller than the average return diameter.

16. The door of claim 10, wherein the average supply diameter is larger than the average return diameter.

17. The door of claim 10, wherein the air flowing through the supply conduit is in heat exchange relationship with the air flowing through the return conduit.

18. The door of claim 10, wherein the return conduit defines an outlet that releases air above the doorway.

19. The door of claim 10, wherein the return conduit defines an outlet that releases air to the blower.

20. The door of claim 10, further comprising a heater in heat transfer relationship with the air flowing to the supply conduit and the return conduit.

21. A method of providing heated supply air to an inflatable seal having a cross-sectional shape, the method comprising:
providing a source of forced heated air;
conveying air from the source of forced heated air, down through a supply air path, to a lower end of the inflatable seal; and
exhausting air from a return air path adjacent to the source of forced heated air, wherein a cross-sectional shape of the seal is divided into the supply air path and the return air path.

22. The method of claim 21, wherein exhausting air from the return path comprises exhausting air to atmosphere before being drawn back into the source of forced heated air.

23. The method of claim 21, wherein the air flowing through the supply air path is in heat exchange relationship with the air flowing through the return air path.
